(19) United States
(12) Patent Application Publication
(10) Pub. No.: US 2003/0067902 A1
(43) Pub. Date: Apr. 10, 2003

(54) Method for providing multiple certified radio modules with a baseband

(76) Inventor: Kirk W. Skeba, Fremont, CA (US)

Correspondence Address: Mark L. Watson, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/960,587

(22) Filed: Sep. 21, 2001

(51) Int. Cl. H04Q 7/24

(52) U.S. Cl. 370/338; 370/381

(57) ABSTRACT

According to one embodiment, a method is disclosed. The method includes receiving a first identification (ID) at a computer system from a server via a transmission medium, comparing the first ID with a second ID stored at a first analog front end coupled to the computer system, and certifying a first software-defined radio for operation if the first ID matches the second ID.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to wireless networks; more particularly, the present invention relates to software radio applications.

### BACKGROUND

Radio applications that are implemented at computer systems are typically approved for a specific set of technical parameters. Such parameters include, for example, the operating frequency, output power, and types of radio frequency emissions. Under current Federal Communication Commission (FCC) rules, a manufacturer must apply for a new approval if one or more of the parameters of radio equipment are changed after the equipment has been certified.

With emerging wireless standards, it is becoming more attractive to provide a single digital device coupled to a computer system that can accommodate multiple radio modules that each provides different capabilities. However, providing configurable radios with varying capabilities makes the certification process within the current rules difficult. For example, since new certification would be necessary each time a new radio module is coupled to a device, it is not practical to provide a device that could support a variety of different radio modules.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a network;

FIG. 2 is a block diagram of one embodiment of a computer system;

FIG. 3 is a block diagram of one embodiment of a software radio; and

FIG. 4 is a flow diagram for one embodiment of certifying an analog front end.

### DETAILED DESCRIPTION

A method to provide the ability to interchange radio modules coupled to a digital baseband unit is described. According to one embodiment, a baseband module is coupled to one of various analog front-end (AFE) devices in order to enable a computer system to implement a software radio application via one or more wireless network protocols. In a further embodiment, a server operated by a manufacturer of a software-defined radio is accessed by a computer system via a network in order to download a certified wireless protocol to be operated at the computer system.

An analog front-end identification is transmitted from the server to the computer system along with the protocol in the form of a signed manifest. The signed manifest is validated with a public key stored at the baseband module. Subsequently, it is determined whether the received data has been authenticated. If the data is not authenticated, no certification is granted to use the software radio, processing block 440. Consequently, the software radio will not operate. If the received data is authenticated, the wireless protocol is executed at the baseband module and the analog front-end identification is stored.

The stored analog front-end identification stored in the baseband module is compared with an analog front-end identification stored at the analog front-end. If there is a match between the two analog front-end identifications, the software radio is certified and ready for operation. Otherwise, no certification is granted to use the software radio.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs), execution cores, etc.).

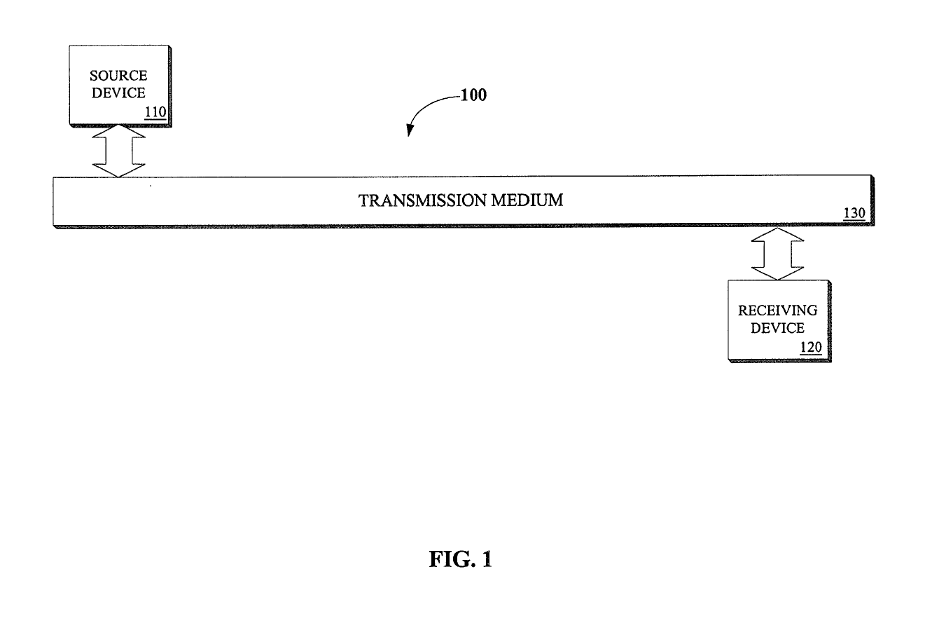

FIG. 1 illustrates one embodiment of a network 100. Network 100 includes a computer system 110 and a computer system 120 coupled via a transmission medium 130. In one embodiment, computer system 110 operates as a source device that sends an object to computer system 120, operating as a receiving device. The object may be, for example, a data file, an executable, or other digital objects. The object is sent via data transmission medium 130.

The data transmission medium 130 may be one of many mediums such as an internal network connection, an Internet connection, or other connections. The transmission medium 130 may be connected to a plurality of un-trusted routers (not shown) and switches (not shown) that may include the integrity of the object that is transmitted.

According to one embodiment, computer system 110 transmits a signed manifest along with the object to computer system 120. The signed manifest is a document that attests to the object's integrity. In one embodiment, the signed manifest includes a digest value generated from applying a digest algorithm on an integrity value from the object, and instructions on how to recompute the digest values. The signed manifest may be used by computer system 120 to verify the integrity of the object.

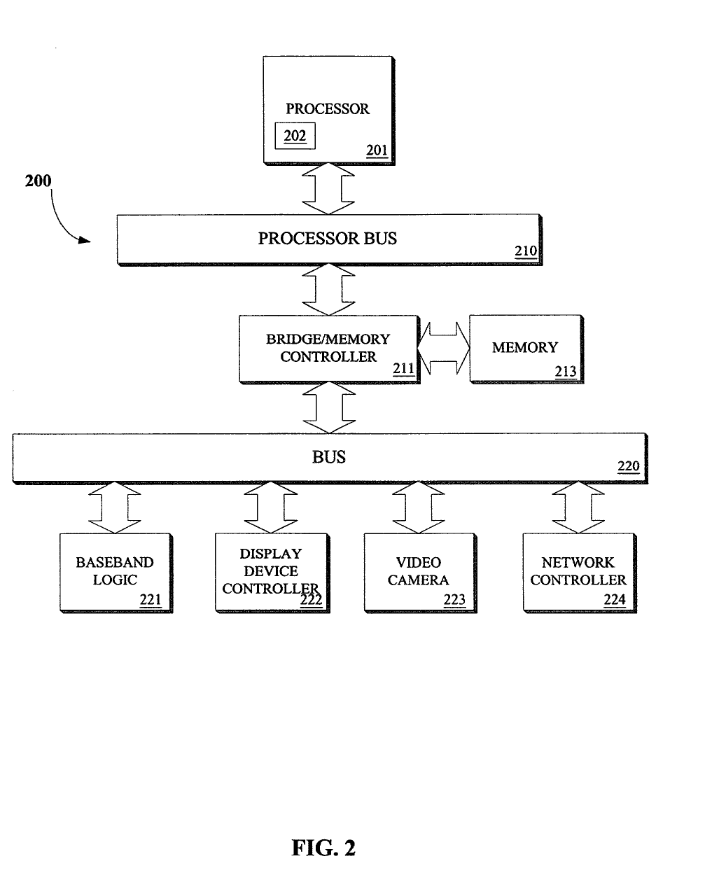

FIG. 2 is a block diagram of one embodiment of a computer system 200. Computer system 200 may be implemented as computer system 110 or computer system 120 (both shown in FIG. 1). The computer system 200 includes a processor 201 that processes data signals. Processor 201 may be a complex instruction set computer (CISC) microprocessor, a reduced instruction set computing (RISC) microprocessor, a very long instruction word (VLIW) microprocessor, a processor implementing a combination of instruction sets, or other processor device.

In one embodiment, processor 201 is a processor in the Pentium® family of processors including the Pentium® 4 family and mobile Pentium® and Pentium® 4 processors available from Intel Corporation of Santa Clara, Calif. Alternatively, other processors may be used. FIG. 2 shows an example of a computer system 200 employing a single processor computer. However, one of ordinary skill in the art will appreciate that computer system 200 may be implemented using multiple processors.

Processor 201 is coupled to a processor bus 210. Processor bus 210 transmits data signals between processor 201 and other components in computer system 200. Computer system 200 also includes a memory 213. In one embodiment, memory 213 is a dynamic random access memory (DRAM) device. However, in other embodiments, memory 213 may be a static random access memory (SRAM) device, or other memory device.

Memory 213 may store instructions and code represented by data signals that may be executed by processor 201. According to one embodiment, a cache memory 202 resides within processor 201 and stores data signals that are also stored in memory 213. Cache 202 speeds up memory accesses by processor 201 by taking advantage of its locality of access. In another embodiment, cache 202 resides external to processor 201.

Computer system 200 further includes a bridge memory controller 211 coupled to processor bus 210 and memory 213. Bridge/memory controller 211 directs data signals between processor 201, memory 213, and other components in computer system 200 and bridges the data signals between processor bus 210, memory 213, and a first input/output (I/O) bus 220. In one embodiment, I/O bus 220 may be a single bus or a combination of multiple buses.

In a further embodiment, I/O bus 220 may be a Peripheral Component Interconnect adhering to a Specification Revision 2.1 bus developed by the PCI Special Interest Group of Portland, Oreg. In another embodiment, I/O bus 220 may be a Personal Computer Memory Card International Association (PCMCIA) bus developed by the PCMCIA of San Jose, Calif. Alternatively, other busses may be used to implement I/O bus. I/O bus 220 provides communication links between components in computer system 200.

A display device controller 222 is also coupled to I/O bus 220. Display device controller 222 allows coupling of a display device to computer system 200, and acts as an interface between the display device and computer system 200. In one embodiment, display device controller 222 is a monochrome display adapter (MDA) card.

In other embodiments, display device controller 222 may be a color graphics adapter (CGA) card, an enhanced graphics adapter (EGA) card, an extended graphics array (XGA) card or other display device controller. The display device may be a television set, a computer monitor, a flat panel display or other display device. The display device receives data signals from processor 201 through display device controller 222 and displays the information and data signals to the user of computer system 200. A video camera 223 is also coupled to I/O bus 220.

A digital baseband unit 221 is coupled to I/O bus 220. In one embodiment, baseband unit 221 is coupled to one of various analog front-end devices in order to enable computer system 200 to implement a software radio application via one or more wireless network protocols. In other embodiments, baseband unit 221 may be incorporated within bridge/memory controller 211.

A network controller 224 is also coupled to I/O bus 220. Network controller 224 links computer system 200 to a network of computers (not shown in FIG. 2) and supports communication among the machines. According to one embodiment, network controller 224 enables computer system 200 to access a server in order to download data needed to certify a software radio application.

Traditionally, each type of radio device (e.g., baseband+analog front-end) is approved for a specific set of technical parameters (e.g., the operating frequencies, output power, and types of radio frequency emissions). With emerging wireless standards, it is becoming more attractive to provide a single digital device coupled to a computer system that can accommodate multiple radio modules that each provides different capabilities.

However, under current FCC rules, a manufacturer would have to apply for a new approval if the parameters of a radio device are even slightly changed after the device has been certified. As a result, providing configurable radios with varying capabilities makes the certification process within the current rules difficult. For example, since new authorization would be necessary each time a new radio module is coupled to a device, it would not have been practical in the past to provide a device that could support a variety of different radio modules.

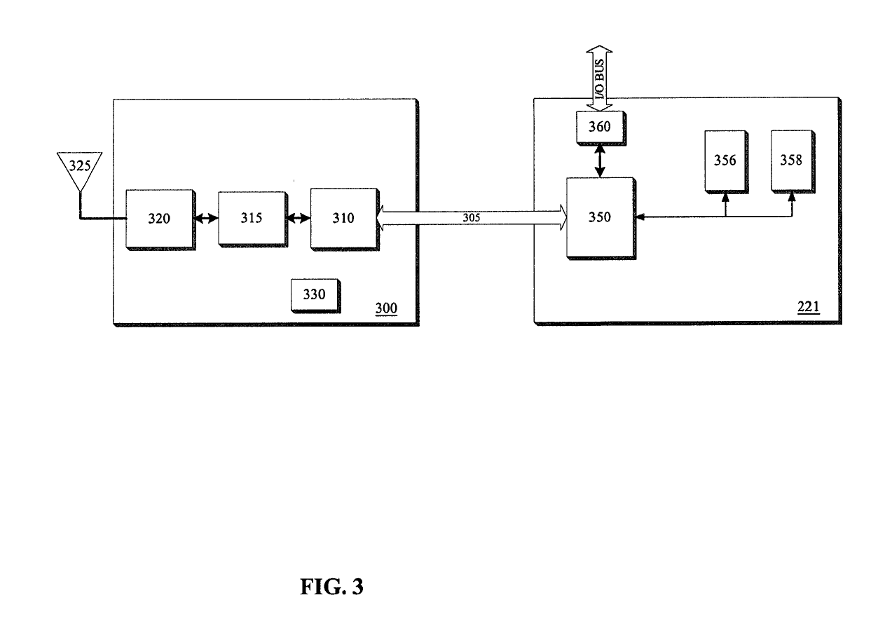

According to one embodiment, a method to provide the ability to interchange radio modules coupled to a digital baseband unit is disclosed. The method disclosed below enables the incremental deployment of new or emerging radio standards to be added to baseband unit 221 and certified when available. Thus, allowing the life of the radio hardware to be extended. FIG. 3 is a block diagram of one embodiment of a software radio. The software radio includes baseband unit 221 coupled to an analog front end (AFE) 300.

Referring to FIG. 3, baseband unit 221 includes digital signal processor DSP 350, interface logic 360, volatile memory 356 and non-volatile memory 358. DSP 350 processes instructions and data received at baseband unit 221. DSP 350 integrates a processor core, a program memory device, and application-specific circuitry on a single integrated circuit die. One of ordinary skill in the art will appreciate that one or more of the DSPs may be replaced with other components (e.g., field programmable gate arrays (FPGAs) without departing from the scope of the invention).

Interface logic 360 is coupled to DSP 350. Interface logic 360 connects baseband unit 221 with the host platform of computer system 200. In one embodiment, interface logic 360 includes circuitry that enables baseband unit 221 to interface with I/O bus 220. Volatile memory 356 stores instructions and code represented by data signals that may be executed by DSP 350. According to one embodiment, memory 356 is a static random access memory (SRAM). However, one of ordinary skill in the art will appreciate that other types of volatile memory devices may be implemented.

Non-volatile memory 358 also stores instructions and code that are executed by DSP 350. In addition, non-volatile memory 358 stores programs that are important to DSP 350. In one embodiment, memory 358 is a programmable read only memory (PROM). However, memory 358 may be implemented using other non-volatile memory devices.

Baseband unit 221 is coupled to AFE 300 via a bus 305. AFE 300 includes analog-digital/digital-analog (AD/DA) conversion logic 310, modulation 315, transceiver 320, antenna 325 and non-volatile memory 330. AD/DA conversion logic 310 is coupled to bus 305. AD/DA conversion logic 310 converts analog signals at AFE 300 to digital signals prior to transmission to baseband unit 221 via bus 305. Moreover, AD/DA conversion logic 310 converts digital signals received from baseband unit 221 to analog signals. Modulation 315 is coupled to AD/DA conversion logic 310 and modulates the analog data to place the data in an intermediate frequency range. Modulation 315 also demodulates data received at AFE 300.

Transceiver 320 is coupled to modulation 315. Transceiver 320 receives and transmits data from AFE 300 on air. Transceiver 320 includes a power amplifier that amplifies the modulated data prior to transmission. Further, transceiver 320 operates in a complementary manner when receiving data. Specifically, antenna 325 supplies the received data to transceiver 320. The packet is then demodulated and decoded to obtain a baseband packet, which it supplied to baseband unit 221.

As described above with respect to memory device on-volatile memory 358, non-volatile memory 330 stores programs that are important to DSP 350. In particular, memory 330 stores an AFE identification (ID). The AFE ID is a cryptographic key that is used to provide authentication that AFE 300 has been certified by the FCC to operate with broadband unit 221. In one embodiment, memory 330 is a programmable read only memory (PROM). However, memory 330 may be implemented using other non-volatile memory devices.

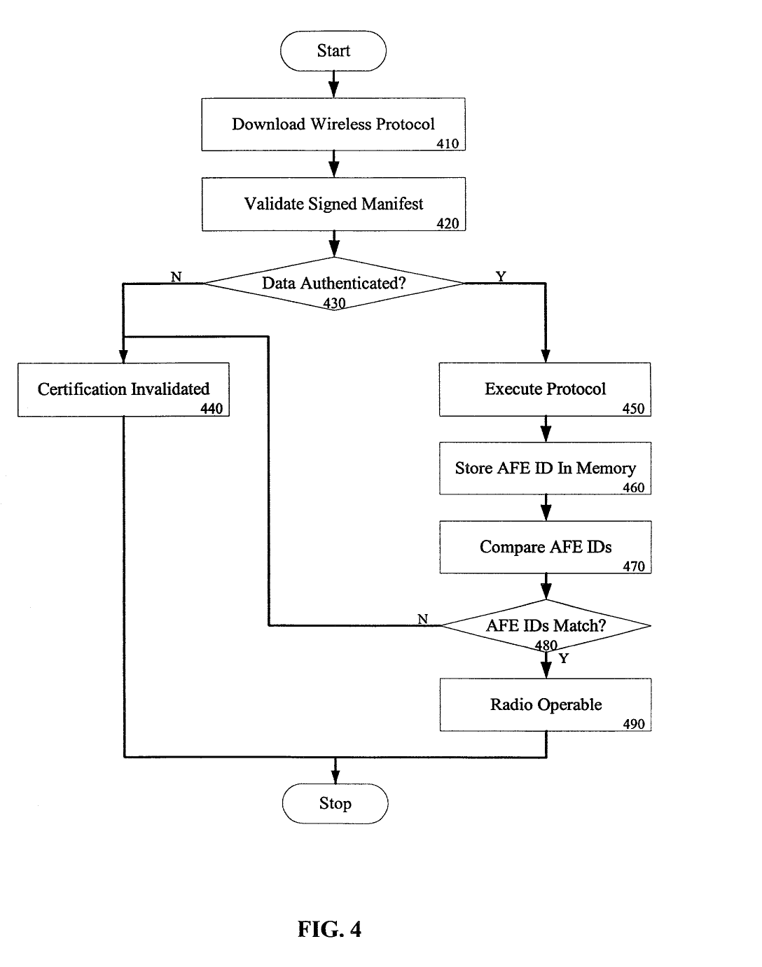

According to one embodiment, AFE 300 may be implemented using one of a plurality of analog radio devices. For instance, AFE 300 may be implemented with a 2.4 or 5.1 gigahertz radio, as well as radios operating at other frequencies. Therefore, each AFE 300 that is coupled to baseband unit 221 may be easily certified using the cryptographic key stored within memory 330. FIG. 4 is a flow diagram for one embodiment of certifying a new AFE 300 that is coupled to baseband unit 221.

Referring to FIG. 4, a source device (e.g., computer system 110) is accessed by the receiving device (e.g., computer system 120) at which the software defined radio (e.g., the baseband unit 221/AFE 300 combination) in order to download a wireless protocol to be operated at computer system 120, processing block 410. In one embodiment, information regarding the capabilities of baseband unit 221 and the particular AFE 300 is transmitted from computer system 120 to computer system 110 via transmission medium 130. As a result, computer system 110 transmits the certified protocol.

According to one embodiment, computer system 110 may be an Internet site operated by a manufacturer of AFE 300. In such an embodiment, the FCC may certify various radio protocols and supervise the manufacturers site to ensure the proper certification of software radios. Since the radio is controlled by software operation, the manufacture is responsible for authenticating software/firmware that is transmitted and loaded at computer system 120. However, in other embodiments, computer system 110 may be an Internet site operated by the FCC, thus enabling the FCC to directly monitor the certification of software radios.

According to a further embodiment, the AFE ID for the AFE 300 being implemented at computer system 120 is transmitted with the protocol in the form of a signed manifest. As discussed above, the signed manifest is used by computer system 120 to verify the integrity of the data received from computer system 110. At processing block 420, the signed manifest is validated with a public key stored at non-volatile memory 358. At decision block 430, it is determined whether the received data has been authenticated. If the data is not authenticated, the certification process is invalidated and no certification is granted to use the software radio, processing block 440. As a result, the software radio will not operate.

If, however, the received data is authenticated, the wireless protocol is executed at DSP 350, processing block 450. At processing block 460, the received AFE ID is extracted from the protocol stored in memory 356. At processing block 470, the AFE ID stored within the protocol is compared with the AFE ID stored in non-volatile memory 330. At decision block 480, it is determined whether there is a match between the stored AFE IDs. If there is not a match between the AFE IDs, control is returned to processing block 440 where the certification process is invalidated and no certification is granted to use the software radio. Otherwise, the software radio is certified and ready for operation, processing block 490.

The method described herein will enable the approval of software radio products that include changeable protocols.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A method comprising:
receiving a first identification (ID) at a computer system from a server via a transmission medium;
comparing the first ID with a second ID stored at a first analog front end coupled to the computer system; and
certifying a first software-defined radio for operation if the first ID matches the second ID.

2. The method of claim 1 further comprising disabling the first software-defined radio if the first ID does not match the second ID.

3. The method of claim 1 further comprising storing the first ID in a memory device within a baseband unit at the computer system prior to comparing the first ID with the second ID.

4. The method of claim 1 further comprising downloading a protocol corresponding with the first software-defined radio.

5. The method of claim 4 wherein the first ID and the wireless protocol are received as a component of a signed manifest.

6. The method of claim 5 further comprising:
validating the signed manifest; and
executing the protocol at a baseband unit if the manifest is validated.

7. The method of claim 1 further comprising:
receiving a third identification (ID) at the computer system from the server via the transmission medium;
comparing the third ID with a fourth ID stored at a second analog front end coupled to the computer system; and
certifying a second software-defined radio for operation if the third ID matches the fourth ID.

8. A computer system comprising a first software-defined radio including:
a baseband unit; and
a first analog front-end coupled to the baseband unit;
the first software-defined radio being certified for operation by authenticating a first identification (ID) received at the baseband unit with a second ID stored at the first analog front end.

9. The computer system of claim 8 further comprising:
an input/output (I/O) bus coupled to the baseband unit; and
a network controller coupled to the I/O bus.

10. The computer system of claim 9 wherein the first ID is received from a server computer via a transmission medium coupled to the network controller.

11. The computer system of claim 10 wherein a protocol corresponding to the first software-defined radio is also received from the server computer.

12. The computer system of claim 9 wherein the baseband unit comprises:
an I/O interface coupled to the I/O bus;
a digital signal processor (DSP) coupled to the I/O interface; and
a second bus coupled to the DSP.

13. The computer system of claim 12 wherein the baseband unit further comprises:
a volatile memory coupled to the DSP; and
a non-volatile memory coupled to the DSP.

14. The computer system of claim 12 wherein the analog front end comprises:
analog-digital/digital-analog (AD/DA) conversion logic coupled to the second bus;
modulation logic coupled to the AD/DA conversion logic;
a transceiver coupled to the modulation logic; and
an antenna coupled to the transceiver.

15. The computer system of claim 14 wherein the analog front end comprises a non-volatile memory that stores the second ID.

16. The computer system of claim 12 further comprising a second software-defined radio including:
the baseband unit; and
a second analog front-end coupled to the baseband unit;
the second software-defined radio being certified for operation by authenticating a third ID received at the baseband unit with a fourth ID stored at the second analog front end.

17. A network comprising:
a first client computer;
a transmission medium coupled to the first client computer; and
a server computer, coupled to the transmission medium, that transmits first identification (ID) data to the first client computer upon receiving a request from the client computer to certify a first software-defined radio implemented at the first client computer.

18. The network of claim 17 further comprising a second client computer coupled to the transmission medium, the server computer transmits the first ID data to the second client computer upon receiving a request from the second client computer to certify the first software-defined radio implemented at the second client computer.

19. The network of claim 17 wherein the server computer transmits second ID data to the first client computer upon receiving a request from the first client computer to certify a second software-defined radio implemented at the first client computer.

20. A method comprising:
receiving a request at a server computer to certify a first software-defined radio implemented at a first client computer; and
transmitting first identification (ID) data corresponding to the first software-defined radio to the first client computer.

21. The method of claim 21 further comprising transmitting a radio protocol corresponding to first software-defined radio to the to the first client.

22. The method of claim 20 further comprising:
receiving a request at the server computer to certify the first software-defined radio implemented at a second client computer; and
transmitting the first ID data to the second client computer.

23. The method of claim 20 further comprising:
receiving a request at the server computer to certify a second software-defined radio implemented at the first client computer; and
transmitting second ID data corresponding to the second software-defined radio to the second client computer.
